(19) United States
(12) Patent Application Publication
(10) Pub. No.: US 2020/0061700 A1
(43) Pub. Date: Feb. 27, 2020

(54) SPREADABLE POWDER PASTES FOR ADDITIVE MANUFACTURING

(71) Applicant: GM Global Technology Operations LLC, Detroit, MI (US)

(72) Inventors: Tyson W. Brown, Royal Oak, MI (US); Anil K. Sachdev, Rochester Hills, MI (US); William R. Rodgers, Bloomfield Township, MI (US)

(73) Assignee: GM Global Technology Operations LLC, Detroit, MI (US)

(21) Appl. No.: 16/112,110

(22) Filed: Aug. 24, 2018

(51) Int. Cl. B22F 1/00; B33Y 10/00; B33Y 30/00; B33Y 70/00; B22F 3/105; B33Y 40/00

(52) U.S. Cl. CPC B22F 1/0062; B33Y 10/00; B33Y 30/00; B22F 9/082; B22F 3/1055; B33Y 40/00; B33Y 70/00

(57) ABSTRACT

Systems and methods for additive manufacturing of a metallic component using a metal-powder paste are described. The metal-powder paste is a mixture including a non-uniform metal powder and a flowable additive. The metal-powder paste is applied to a surface of a substrate and spread to thereby produce a uniform-thickness layer in areas corresponding to the metallic component. The flowable additive is driven off using thermal energy to thereby form a layer of the non-uniform metal powder having a uniform thickness. The non-uniform metal powder is then fused to the substrate to thereby form the metallic component.

### INTRODUCTION

The disclosure relates to the field of additive manufacturing and, more specifically, to systems and methods employing spreadable powder pastes for use in additive manufacturing.

Forming metallic components using additive manufacturing spreads thin layers of powder in a generally linear motion. A microspherical morphology is used to allow for spreadability of the powder. Intensive processes, such as plasma atomization/spheroidization, are employed to produce the substantially uniform microspherical powders.

Powders with non-uniform morphologies, e.g., angular powders and/or powders with non-uniform or broad size distributions, generally cannot be used in additive manufacturing. These powders are not generally spreadable. Rather, spreading of non-uniform powders produces non-uniform heights of the powder, voids within the powder layer, large density fluctuations throughout the layer, etc.

### SUMMARY

Systems and methods in accordance with the present disclosure optimize additive manufacturing of metallic components. According to aspects of the present disclosure, non-uniform metal powders may be used to form metallic components through additive manufacturing. Beneficially, this reduces cost and intensiveness of producing metallic components through additive manufacturing. Moreover, according to aspects of the present disclosure, longevity of metallic powders used in additive manufacturing may be increased, which thereby further optimizes additive manufacturing of metallic components.

According to aspects of the present disclosure, a method of forming a metallic component employing a metal-powder paste is described. The metal-powder paste is a mixture including a metal powder and a flowable additive. The method includes applying the metal-powder paste to a surface of a substrate, spreading the metal-powder paste to thereby produce a uniform-thickness layer in areas corresponding to the metallic component, driving off the flowable additive using thermal energy to thereby form a layer of the metal powder having a uniform thickness; and fusing the metal powder to the substrate to thereby form the metallic component through additive manufacturing. The flowable additive is driven off after the spreading.

According to further aspects of the present disclosure, driving off the flowable additive occurs solely in the areas corresponding to the metallic component.

According to further aspects of the present disclosure, the metal powder is a non-uniform metal powder.

According to further aspects of the present disclosure, driving off the flowable additive occurs immediately after spreading the metal-powder paste.

According to further aspects of the present disclosure, fusing the metal powder occurs immediately after driving off the flowable additive.

According to further aspects of the present disclosure, the flowable additive includes agar, gellan, acrylic acids, polysaccharides, starches, polydimethylsiloxane, or combinations thereof.

According to further aspects of the present disclosure, the metal powder includes angular powder.

According to further aspects of the present disclosure, the metal powder is produced using water atomization.

According to further aspects of the present disclosure, a low-intensity light source provides the thermal energy, and wherein a high-intensity laser fuses the metal powder to the substrate.

According to further aspects of the present disclosure, the low-intensity light source is an infrared light source.

According to aspects of the present disclosure, method of forming an additive manufacturing material is disclosed. The method includes selecting a metal powder configured to be fused via a fusion mechanism and mixing the metal powder with a flowable additive to thereby produce a metal-powder paste. The metal-powder paste is a semi-solid that is spreadable to form a uniform thickness layer.

According to further aspects of the present disclosure, wherein the metal powder includes angular powder.

According to further aspects of the present disclosure, the metal powder is produced using water atomization.

According to further aspects of the present disclosure, the metal powder is non-uniform and the flowable additive includes agar, gellan, acrylic acids, polysaccharides, starches, polydimethylsiloxane, or combinations thereof.

According to aspects of the present disclosure, a system configured to form a metallic component includes a bed, a spreader, a heat source, and a fusion mechanism. The bed is configured to support a substrate having a metal-powder paste thereon. The metal-powder paste is a mixture including a non-uniform metal powder and a flowable additive. The spreader is configured to spread the metal-powder paste through physical manipulation to thereby produce a uniform-thickness layer of the metal-powder paste. The heat source is configured to apply thermal energy to the metal-powder paste to drive away the flowable additive and thereby form a layer of the non-uniform metal powder having a uniform thickness. The fusion mechanism is configured to fuse the non-uniform metal powder to the substrate to thereby form the metallic component through additive manufacturing.

According to further aspects of the present disclosure, the flowable additive includes agar, gellan, acrylic acids, polysaccharides, starches, polydimethylsiloxane, or combinations thereof.

According to further aspects of the present disclosure, the non-uniform metal powder includes angular powder.

According to further aspects of the present disclosure, the non-uniform metal powder is produced using water atomization.

According to further aspects of the present disclosure, a head is configured to translate relative to the bed.

According to further aspects of the present disclosure, the head includes the spreader and the heat source.

According to further aspects of the present disclosure, the head includes the heat source and the fusion mechanism.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 is a schematic illustration of a system configured to form metallic components, according to aspects of the present disclosure;

FIG. 2 is a method of forming metallic components using a metal-powder paste, according to aspects of the present disclosure;

FIG. 3 is a method of forming a metal-powder paste, according to aspects of the present disclosure.

### DETAILED DESCRIPTION

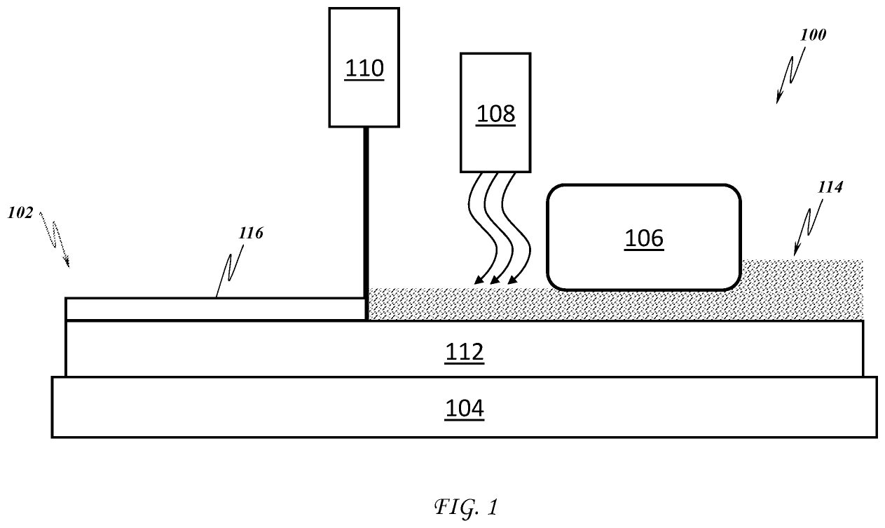

Systems and methods in accordance with the present disclosure employ a spreadable metal powder paste for use in additive manufacturing processes. Referring now to FIG. 1, a schematic view of a system 100 configured to form a metallic component 102 is shown. The system 100 includes a bed 104, a spreader 106, a heat source 108, and a fusion mechanism 110.

The bed 104 is configured to support the metallic component 102 during additive manufacturing processes. The metallic component 102 includes a substrate 112 with a metal-powder paste 114 applied thereto. The metal-powder paste 114 is a semi-solid material that is manipulable for spreading. The metal-powder paste 114, when spread, is configured to maintain a predetermined thickness with a cross-sectional profile that is substantially similar to a cross-sectional profile of a spread layer of a microspherical powder.

The metal-powder paste 114 includes a non-uniform metal powder and a flowable additive. The non-uniform metal powder includes one or more pure metals or metal alloys. As used herein, “non-uniform powders” refers to metallic powders that include angular morphologies, non-uniform size distributions (e.g., particle size distributions that do not follow a normal Gaussian distribution), and/or broad size distributions. The non-uniform metal powders may be fine metal powders having a D90 of less than 100 microns. In some aspects, the non-uniform metal powders may have a D90 of less than 50 microns. D90 is defined as the size which 90% of the sample lies below. That is, a D90 of 100 microns means that 90% of the particles in the sample have a size of less than 100 microns. In some aspects, the non-uniform metal powder includes powders formed via water atomization.

The flowable additive is configured to optimize viscosity of the metal-powder paste. The flowable additive is a material having a boiling point and decomposition temperature that is above an ambient temperature. The material of the flowable additive also has at least one of the boiling point or the decomposition temperature below a predetermined temperature. The predetermined temperature is selected such that the flowable additive may be evaporated or decomposed to produce a substantially solid metal powder consisting essentially of the non-uniform metal powder. In some aspects, the boiling point and the decomposition temperature is above 100° C. and at least one of the boiling point and the decomposition temperature is less than 95% of the melting point of metals within the non-uniform metal powder. In some aspects, at least one of the boiling point and the decomposition temperature is less than 90% of the melting point of metals within the non-uniform metal powder. In some aspects, at least one of the boiling point and the decomposition temperature is less than 80% of the melting point of metals within the non-uniform metal powder.

The flowable additive is selected such that, after the flowable additive is driven away, residue on the non-uniform metal powder does not provide detrimental properties of the formed component. In some aspects, no residue remains after the flowable additive is driven away. Beneficially, in some aspects, the flowable additive is configured to leave a residue that optimizes properties of the formed components. In some aspects, the flowable additive provides a residue of carbon in a predetermined amount in response to being driven away to thereby provide or increase carbon content within the resulting component. For example, the non-uniform metal powder may be iron and the residue is carbon to thereby produce a component formed from steel.

The flowable additive is added in amount from about 0.1 wt % to about 5 wt % on a basis of the weight of the additive and the non-uniform metal powder. In some aspects, the flowable additive is configured to provide thixotropic properties to the metal-powder paste 114. For example, the metal-powder paste 114 may be shear thinning such that application of a mechanical stress increases flowability of the metal-powder paste 114. In some aspects, the flowable additive includes agar, gellan, acrylic acids, polysaccharides, starches such as corn or potato, polydimethylsiloxane, combinations thereof, and the like.

Beneficially, the flowable additive can be selected to extend longevity of the non-uniform metal powders within the metal-powder paste 114. Longevity of the non-uniform metal powders is affected by, for example, exposure to atmospheric oxygen during storage and/or additive manufacturing steps. The non-uniform powders will oxidize, and the increased oxygen may negatively affect fusion properties and structure of the formed component. In some aspects, the flowable additive inhibits oxygen from contacting particles of the non-uniform metal powder. In some aspects, the flowable additive scavenges oxygen to thereby inhibit oxidation of the non-uniform metal powder.

The spreader 106 is configured to spread the metal-powder paste 114 through physical manipulation. After the metal-powder paste 114 is laid down on the substrate 112, the spreader 106 is translated relative to the bed 104 and engages the metal-powder paste 114 such that a uniform-thickness layer of the metal-powder paste 114 remains on the substrate 112. The spreader 106 may be configured to impart a stress on the metal-powder paste 114 sufficient to reduce viscosity of the metal-powder paste. For example, the spreader 106 is translated at a predetermined speed and/or vibrated to impart the stress.

The heat source 108 is configured to apply thermal energy to the metal-powder paste 114 to drive away the flowable additive. The flowable additive is driven away through evaporation or decomposition to produce a substantially solid powder consisting essentially of the non-uniform metal powder. For example, trace amounts of the flowable additive or decomposition products may remain after application of the thermal energy, which are then driven off by the fusion mechanism 110. The thermal energy may be applied via conductive, convective, and/or radiative transfer. The heat source 108 may be translated relative to the bed, be provided by heating the substrate 112, and/or raise the ambient temperature proximate the metallic component during forming (e.g., forming the metallic component within an oven).

In some aspects, the heat source 108 is a low-intensity light source. As used herein, “low-intensity light source” is a light source configured to impart an intensity that is sufficient to drive away the flowable additive without fusing the non-uniform metal powder. In some aspects, the low-intensity light source has an output intensity that is sufficient to drive away the flowable additive without fusing the non-uniform metal powder. In some aspects, the low-intensity light source has an output intensity that is sufficient to fuse the non-uniform metal powder and is applied over a predetermined time period that is insufficient to fuse the non-uniform metal powder, thereby imparting the low intensity. For example, the output intensity may be pulsed in predetermined intervals that are insufficient to fuse the non-uniform metal powder and/or the low-intensity light source may be moved at a speed that is too great to fuse the non-uniform metal powder.

The low-intensity light source may be configured to drive away the flowable additive from the metal-powder paste 114 solely in areas to be fused. Beneficially, the low-intensity light source driving away the flowable additive solely in the areas to be fused improves longevity of the metal-powder paste 114 by avoiding recycle processing. In some aspects, the low-intensity light source is configured to produce infrared light.

The fusion mechanism 110 is configured to fuse the non-uniform metal powder into a solid layer 116 bonded to the substrate 112. For example, the fusion mechanism 110 is a high-intensity laser. As used herein, “high-intensity laser” is a laser having an output intensity sufficient to fuse the non-uniform metal powder.

Beneficially, one or more of the spreader 106, the heat source 108, and the fusion mechanism 110 may be simultaneously driven. For example, the spreader 106 and the heat source 108 may be driven simultaneously such that the flowable additive is driven off immediately after spreading. Additionally or alternatively, the heat source 108 and the fusion mechanism 110 may be driven simultaneously such that the non-uniform metal powder is fused into the solid layer 116 immediately after the flowable additive is driven away. In some aspects, the spreader 106, the heat source 108, and/or the fusion mechanism 110 are driven simultaneously by inclusion the same head.

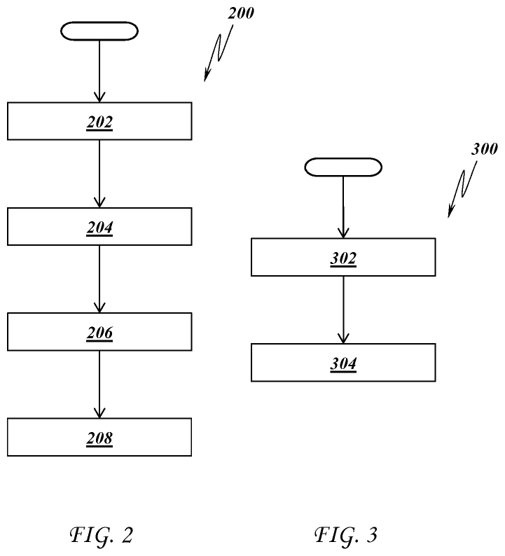

Referring now to FIG. 2, a method 200 of forming the metallic component 102 is shown. The method 200 includes applying 202 a metal-powder paste 114 to a surface of a substrate 112, spreading 204 the metal-powder paste 114 to thereby form a uniform-thickness layer, driving 206 off a flowable additive from the uniform-thickness layer to thereby produce a substantially solid metal powder including a non-uniform metal powder, and fusing 208 the non-uniform metal powder to thereby produce the metallic component.

Referring now to FIG. 3, a method 300 of forming the metal-powder paste 114 is shown. The method 300 includes obtaining 302 a non-uniform metal powder and mixing 304 the non-uniform metal powder with the flowable additive to thereby produce the metal-powder paste 114.

While the foregoing description was made with reference to non-uniform powders, it is contemplated that systems and methods in accordance with the present disclosure may provide benefits to uniform powders. For example, systems and methods in accordance with the present disclosure may extend longevity of uniform powders used in additive manufacturing.

Beneficially, systems and methods in accordance with the present disclosure may be used to produce components formed from atmospherically reactive materials via additive manufacturing. For example the metal powder may be magnesium powder and the flowable additive may inhibit oxygen from contacting the magnesium prior to fusion thereof. Beneficially, the flowable additive may be further configured to provide an inert environment proximate to the metal powder during fusion thereof in response to driving away the flowable additive.

While the best modes for carrying out the disclosure have been described in detail, those familiar with the art to which this disclosure relates will recognize various alternative designs and embodiments for practicing the disclosure within the scope of the appended claims.

What is claimed is:

1. A method of forming a metallic component, the method comprising:
applying a metal-powder paste to a surface of a substrate, the metal-powder paste being a mixture including a metal powder and a flowable additive;
spreading the metal-powder paste to thereby produce a uniform-thickness layer in areas corresponding to the metallic component;
driving off, after the spreading, the flowable additive using thermal energy to thereby form a layer of the metal powder having a uniform thickness; and
fusing the metal powder to the substrate to thereby form the metallic component through additive manufacturing.

2. The method of claim 1, wherein driving off the flowable additive occurs solely in the areas corresponding to the metallic component.

3. The method of claim 1, wherein the metal powder is a non-uniform metal powder.

4. The method of claim 1, wherein fusing the metal powder occurs immediately after driving off the flowable additive.

5. The method of claim 1, wherein the flowable additive includes agar, gellan, acrylic acids, polysaccharides, starches, polydimethylsiloxane, or combinations thereof.

6. The method of claim 1, wherein the metal powder includes angular powder.

7. The method of claim 1, wherein the metal powder is produced using water atomization.

8. The method of claim 1, wherein a low-intensity light source provides the thermal energy, and wherein a high-intensity laser fuses the metal powder to the substrate.

9. The method of claim 8, wherein the low-intensity light source is an infrared light source.

10. A method of forming an additive manufacturing material, the method comprising:
selecting a metal powder configured to be fused via a fusion mechanism; and
mixing the metal powder with a flowable additive to thereby produce a metal-powder paste, the metal-powder paste being semi-solid, the metal-powder paste being spreadable to form a uniform thickness layer.

11. The method of claim 10, wherein the metal powder includes angular powder.

12. The method of claim 10, wherein the metal powder is produced using water atomization.

13. The method of claim 10, wherein the metal powder is non-uniform and the flowable additive includes agar, gellan, acrylic acids, polysaccharides, starches, polydimethylsiloxane, or combinations thereof.

14. A system configured to form a metallic component, the system comprising:
a bed configured to support a substrate having a metal-powder paste thereon, the metal-powder paste being a mixture including a non-uniform metal powder and a flowable additive;
a spreader configured to spread the metal-powder paste through physical manipulation to thereby produce a uniform-thickness layer of the metal-powder paste;
a heat source configured to apply thermal energy to the metal-powder paste to drive away the flowable additive and thereby form a layer of the non-uniform metal powder having a uniform thickness; and
a fusion mechanism configured to fuse the non-uniform metal powder to the substrate to thereby form the metallic component through additive manufacturing.

15. The system of claim 14, wherein the flowable additive includes agar, gellan, acrylic acids, polysaccharides, starches, polydimethylsiloxane, or combinations thereof.

16. The system of claim 14, wherein the non-uniform metal powder includes angular powder.

17. The system of claim 14, wherein the non-uniform metal powder is produced using water atomization.

18. The system of claim 14, further comprising a head configured to translate relative to the bed.

19. The system of claim 18, wherein the head includes the spreader and the heat source.

20. The system of claim 18, wherein the head includes the heat source and the fusion mechanism.
